(19) United States
(12) Patent Application Publication
(10) Pub. No.: US 2015/0336821 A1
(43) Pub. Date: Nov. 26, 2015

(54) SEPARATION OR REMOVAL OF CONSTITUENTS FROM A FLUID

(71) Applicant: ADVANCED MAGNET LAB, INC., Palm Bay, FL (US)

(72) Inventors: Rainer Meinke, Melbourne, FL (US); Ferdinand M Romano, Orlando, FL (US); Nicholas F.L. Romano, Orlando, FL (US)

(21) Appl. No.: 14/761,921

(22) PCT Filed: Jan. 17, 2014
(86) PCT No.: PCT/US14/12139

§ 371 Date: Jul. 17, 2015

Related U.S. Application Data
(60) Provisional application No. 61/753,460, filed on Jan. 17, 2013.

(51) Int. Cl. C02F 1/48; C02F 1/42

(52) U.S. Cl. CPC C02F 1/48; C02F 1/484; C02F 1/42; C02F 2001/422; C02F 2001/425; C02F 2201/48; C02F 2301/08

(57) ABSTRACT

Apparatus and method for removing ions of a common charge type from a fluid. In one embodiment of the method a fluid is passed through a flow region. A magnetic field is applied to the region while the fluid is flowing through the region to provide a magnetic field gradient in the flow region. An electric field is applied across the flow region while the fluid is flowing through the region and while applying the magnetic field to the region.

### RELATED APPLICATION

This application claims priority to provisional patent application U.S. 61/753,460 filed 17 Jan. 2013.

### FIELD OF THE INVENTION

This invention relates to electromagnetic systems and, more particularly, to systems and methods which remove materials from fluids.

### BACKGROUND

It has long been a desire to efficiently and economically remove a variety of constituents from fluids. Common examples include removal of a component in a mixture or removal of a solute, e.g., for water purification, desalination or recovery a constituent. Conventional technologies for doing such are energy consumptive but, in the absence of more cost effective approaches, these technologies provide important benefits. One of the more cost competitive approaches to desalination involves use of semipermeable membranes to provide drinking water from brackish water or from sea water. While these systems are advantageous over thermal distillation systems, transport of product across the membrane requires application of pressure, up to or exceeding 50 bar, depending on the salt concentration of the feed water. Due to the nature of the membrane properties, these systems require pretreatment. For example, membranes in uni-directional flow systems cannot be backwashed to remove accumulations of deposits.

Efforts have also been made to perform purification or desalination based on properties of the constituents. In the case of an ionic compound such as NaCl, with dissociation in an aqueous solution, directed movement of positive and negative ions might, in principal, be based on introduction of Lorentz forces in a flow path traversed by the particles.

### BRIEF DESCRIPTION OF THE FIGURES

FIG. 1A is a partial perspective view of a chamber assembly for processing a solution comprising ions;

FIG. 1B is a partial sectional view of the assembly shown in FIG. 1A;

FIG. 1C is a partial cut-away view of the assembly shown in FIG. 1A taken along a major side wall;

FIG. 2A provides a sectional view of the chamber assembly taken along a plane orthogonal to the major side wall;

FIG. 2B provides a partial view of the chamber apparatus as shown in FIG. 2A;

FIG. 3 is a perspective view of the chamber assembly.

FIG. 4A is a perspective view of an alternate embodiment of the chamber assembly illustrating features along a first side wall;

FIG. 4B is a perspective view of the alternate embodiment of the chamber assembly of FIG. 4A, illustrating features along a second side wall opposite the first side wall;

FIG. 5A is a perspective view of a tubular shaped chamber assembly according to another embodiment of the invention;

FIG. 5B is an end view of the tubular shaped chamber assembly shown in FIG. 5A, taken along a first end of the assembly;

FIG. 5C is an end view of the tubular shaped chamber assembly shown in FIG. 5A, taken along a second end of the assembly; and

FIG. 6 is a block diagram illustrating a multi-stage system which alternately performs ion separation followed by ion removal to cyclically separate and remove cations and anions from a fluid.

Like reference numbers are used throughout the figures to denote like components. Numerous components are illustrated schematically, it being understood that various details, connections and components of an apparent nature are not shown in order to emphasize features of the invention. Various features shown in the figures are not shown to scale in order to emphasize features of the invention.

### DETAILED DESCRIPTION OF THE INVENTION

Before describing in detail exemplary methods, systems and components according to embodiments of the invention, it is noted that the present invention resides primarily in a novel and non-obvious combination of components and process steps. So as to not obscure the disclosure with details that will be readily apparent to those skilled in the art, certain conventional components and steps have been omitted or presented with lesser detail, while the drawings and the specification describe in greater detail elements and steps pertinent to understanding the invention. Further, the following embodiments do not define limits as to structure or method according to the invention, but provide examples which include features that are permissive rather than mandatory and illustrative rather than exhaustive.

While disclosed embodiments of a desalination process are not limited to a particular theory, it is noted that ion pairs, cations and anions, in fluids, may have distinctly different magnetic properties as well as electrical properties. Collectively the combination of properties, associated with each ion in a pair, can influence particle behavior in the presence of strong magnetic and electric fields. The effects, however, may be of a local nature or may be masked in the presence of higher energy activities in the medium such that a net effect due to impressed fields is not readily observed. On the other hand, for example, by limiting the overall energy in a bulk fluid relative to energy transferred via forces impressed on select particles, disassociated ions can undergo net movement in different directions through the fluid. In the case of NaCl, as well as other pairs of cations and anions, the paramagnetic and diamagnetic properties may be relevant such that when a combination of electric and magnetic fields are applied to the aqueous salt medium, the combination of fields can facilitate movement of the Na⁺ ion in a first direction while simultaneously also facilitating movement of the Cl⁻ ion a second direction opposite the first direction. In one instance, when a cation in a solution exhibits paramagnetic properties and an associated anion in the solution exhibits diamagnetic properties, the combination of electric and magnetic fields can facilitate movement of the cation in a first direction while simultaneously also facilitating movement of the anion a second direction opposite the first direction. Further, when cations and anions in an aqueous solution are present in clusters of water molecules, mobility properties are known to change.

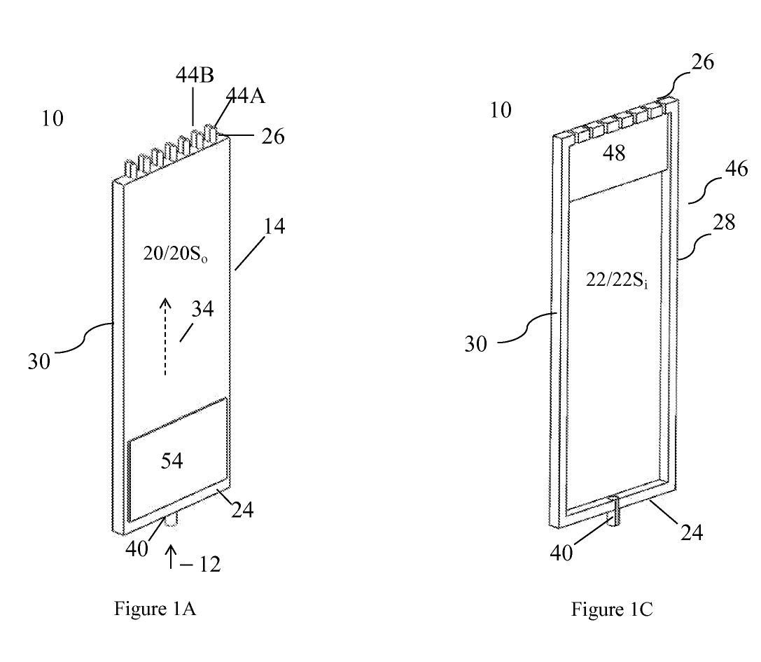

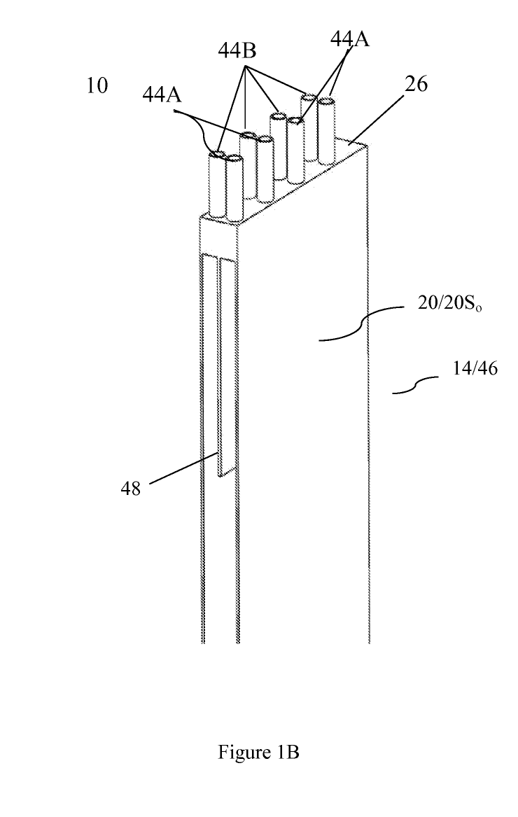

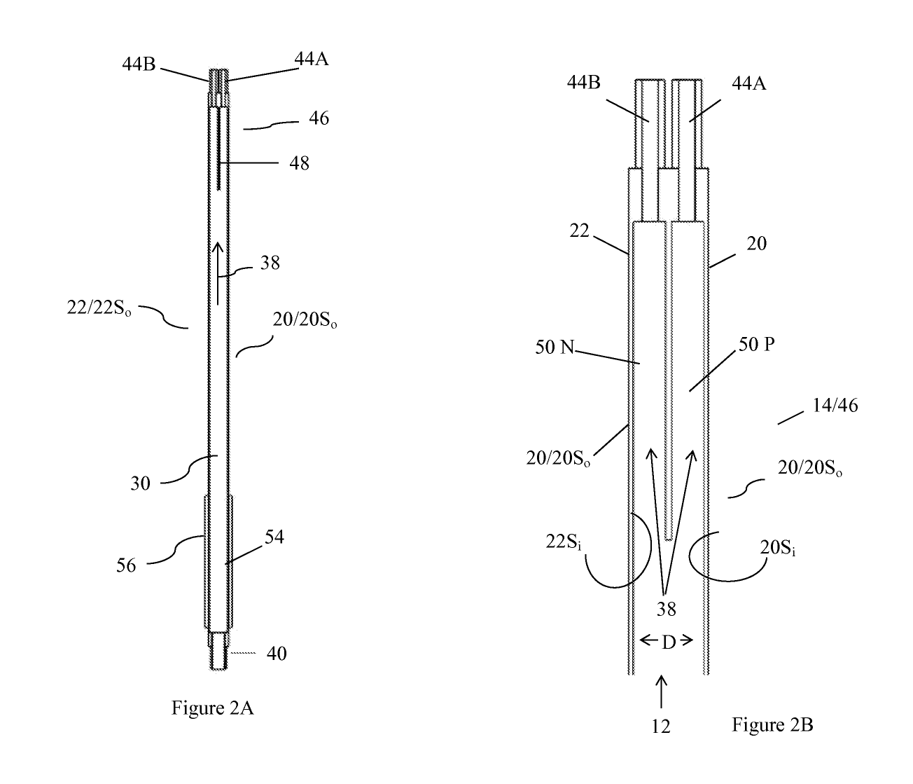

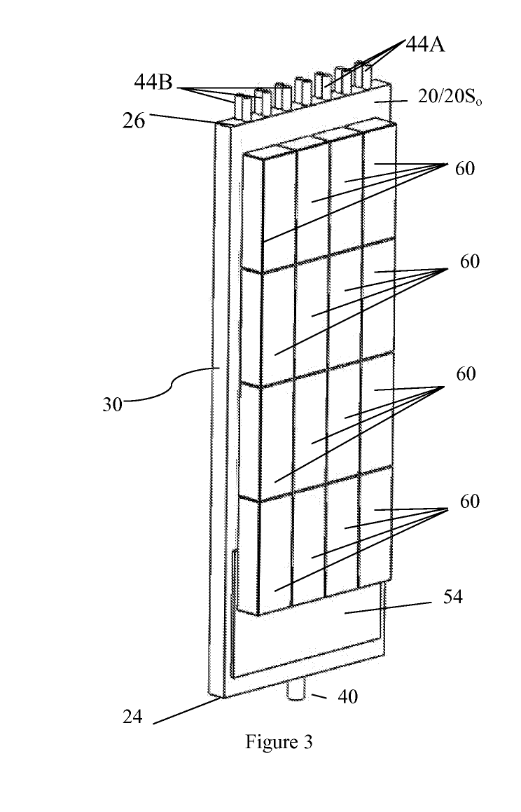

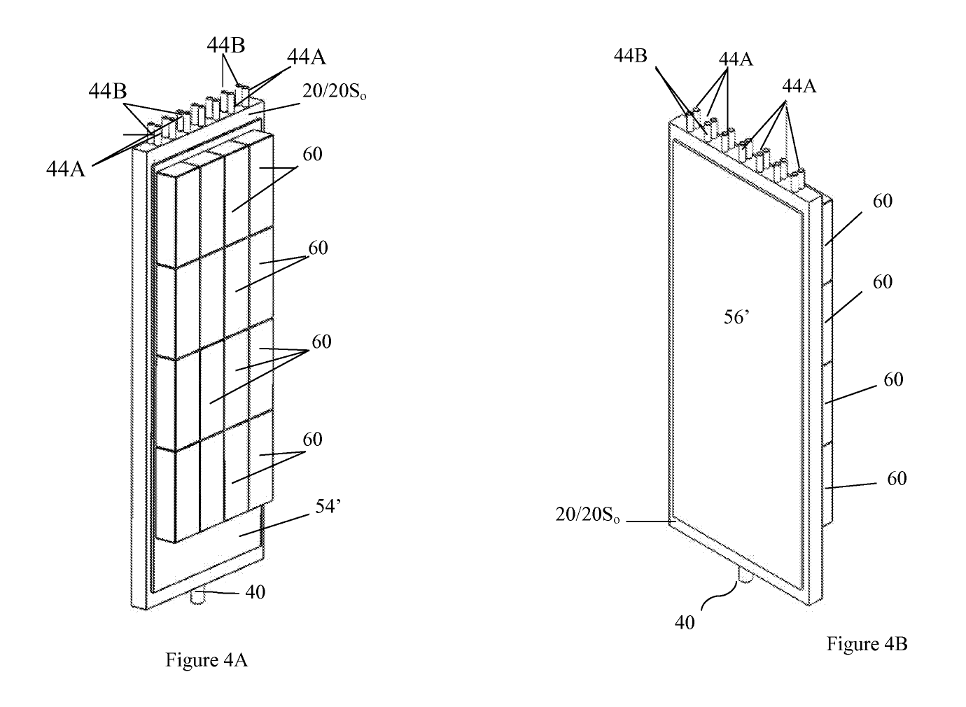

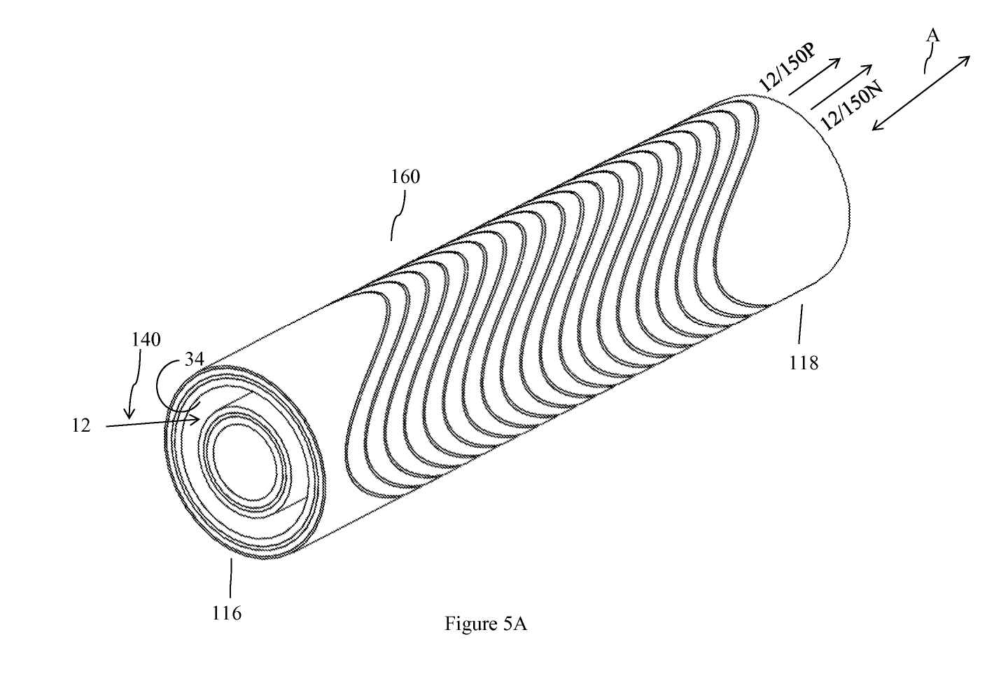

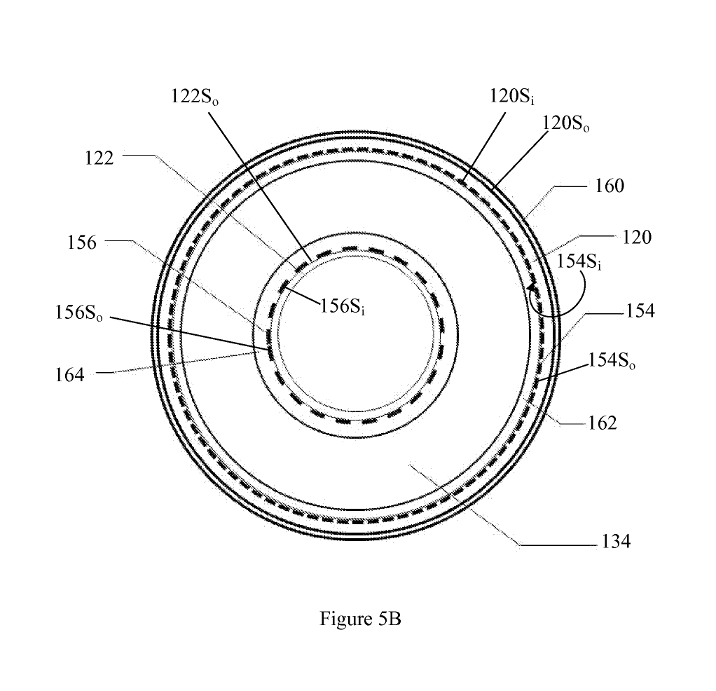

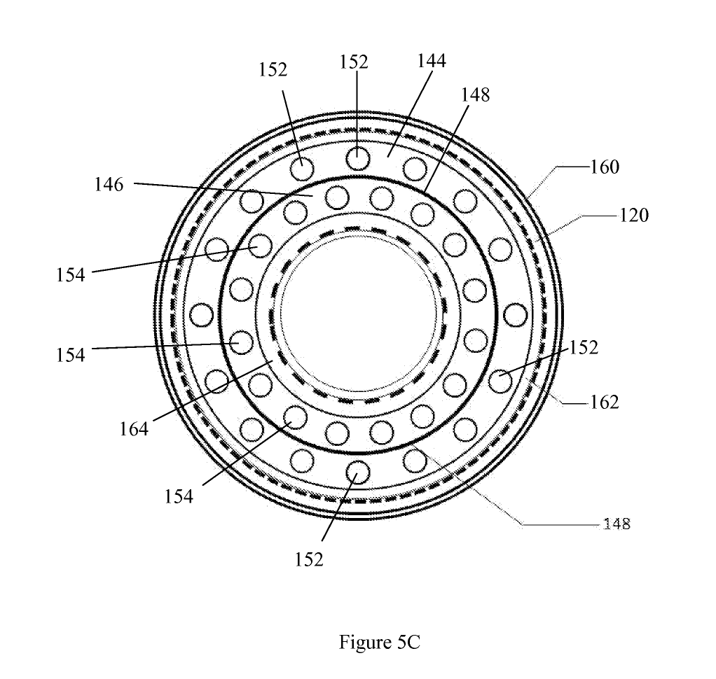

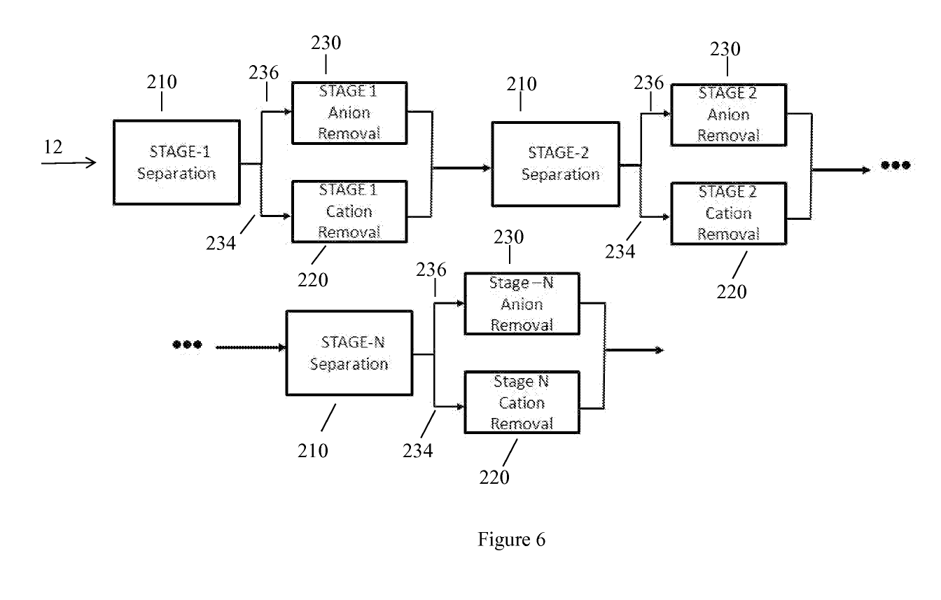

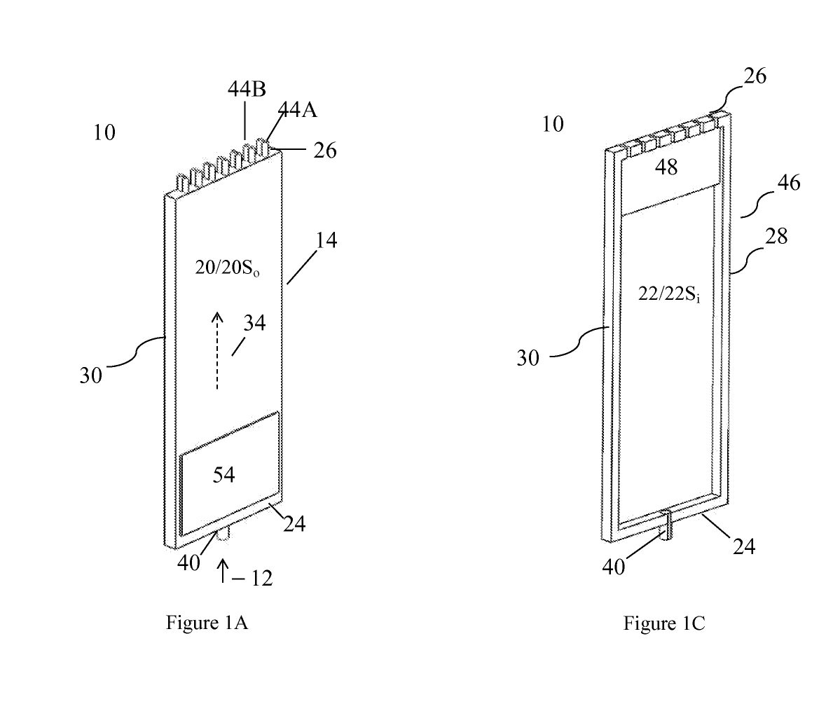

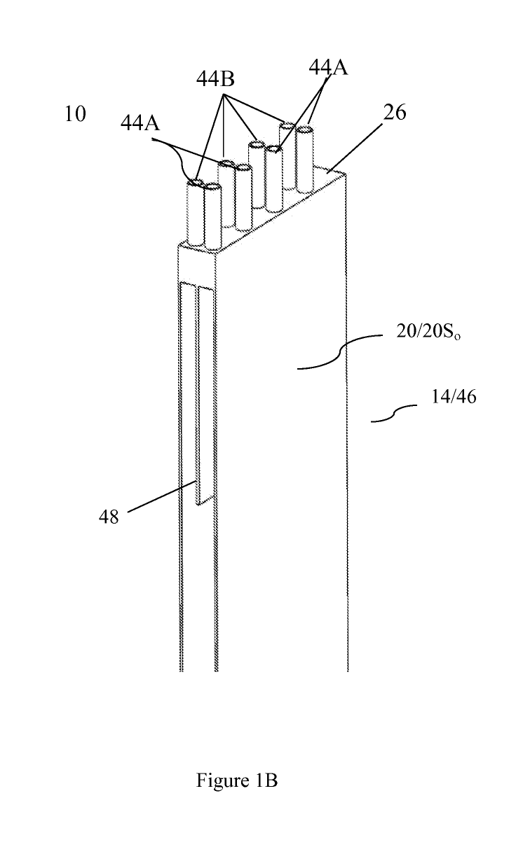

With reference to FIGS. 1 through 4, several perspective views are provided of a chamber apparatus 10 with which ion separation occurs in a fluid 12 flowing through a chamber 14. Operation is based on application of magnetic and electric fields individually or simultaneously. FIG. 1A illustrates the chamber 14 in the exemplary rectangular shape of a box having, for example, interior dimensions of about 0.5 cm×9 cm×35 cm.

The chamber assembly 100 is shown in a vertical orientation with respect to a horizontal ground plane such that the vertical dimension extends above the ground plane. The chamber 14 is bounded by first and second spaced apart major side walls 20, 22 dimensioned approximately 9 cm×35 cm. The major side walls 20, 22 may be flat sheets of acrylic having uniform thickness, with first and second opposing surfaces facing away from one another. An interior surface 20Si of the major side wall 20 faces the interior of the chamber 14 while the opposing surface 20So of the major side wall 20 faces away from the interior of the chamber 14. Similarly, an interior surface 22Si of the major side wall 22 faces the interior of the chamber 14 while the opposing surface 22So of the major side wall 22 faces away from the interior of the chamber 14.

The major side walls 20, 22 may be formed of plastic or other non-conducting material. Horizontally positioned lower and upper opposing end walls 24, 26 of the chamber extend between the major side walls and each are shown in an orientation substantially parallel to the ground plane. Two opposing minor side walls 28, 30 each extend between the lower and upper end walls 24, 26 to further define the chamber interior. The end walls 24, 26 and the minor side walls 28, 30 are each positioned against the two major side walls and are dimensioned to orient the side walls parallel to one another. This provides a uniform spacing, D, between the sidewalls 20, 22 along the entire extent of the chamber 14. With this arrangement the interior surfaces 20Si and 22Si of the major sidewalls are parallel to one another, thereby providing the chamber interior a uniform width based on the distance between the surfaces. In other embodiments the chamber interior may not be of uniform width.

A flow path 34 for movement of fluid 12 through the chamber 14 extends from the lower end wall 24 to the upper end wall 26 and between the minor side walls 28, 30. During operation, the fluid 12 initially enters the chamber 14 via an inlet 40 which passes through the lower end wall and fills the chamber. Two groups or rows of outlets 44A and 44B extend through the upper chamber end wall 26 so that after the majority of the chamber becomes filled with fluid, the fluid 38 egresses from the chamber through the outlets 44A and 44B. A gravity feed system, in lieu of a pump, may be used to slowly or intermittently add water to fill the chamber at an adjustable flow rate. Although the chamber is shown in a vertical orientation, other orientations are suitable for operation. For example, the chamber 14 may be rotated by ninety degrees about a plane along which the wall 20 extends so that the lower and upper end walls 24, 26 extend in a vertical direction with respect to the horizontal ground plane. Although a single inlet 40 is illustrated in the embodiments of FIGS. 1-4, the chamber assembly 10 may have multiple inlets distributed along and extending through the lower end wall 24.

FIG. 1B is a sectional view of an upper portion 46 of the chamber apparatus 10 taken along a plane orthogonal to the major side walls 20 and 22. FIG. 1C is a partial perspective view of the chamber apparatus 10. FIGS. 1B and 1C illustrate features along the upper portion 46 of the assembly 10. A divider plate 48 within the chamber 10 extends from the upper end wall 26 approximately 3 cm toward the lower end wall 24 to divide a portion of the chamber 10 into two separated channels 50P, 50N of approximately equal size. The first channel, 50P, extends between the divider plate 48 and the first major side wall 20. The second channel 50N extends between the divider plate 48 and the second major side wall 22. The outlets 44A and 44B extend into different channels to receive fluid moving along the flow path. The outlets 44A only receive flow from the first channel 50P and the outlets 44B only receive flow from the second channel 50N. Consequently, fluid 12 flowing through each distinct channel, 50P or 50N, is only passed through one group of outlets, 44A or 44B, for further processing, e.g., removal of cations or anions.

The walls of the chamber may be formed of acrylic sheets or other non-magnetic, non-conductive material, e.g., a polymer. The walls may also be formed of a non-magnetic metal with portions of the walls along the chamber interior having an insulative material formed thereover to electrically isolate fluid in the flow path if the walls are used as field plates. An advantageous feature is that relatively thin sheets of acrylic may be used for the major side walls as well as the divider plate 48 to reduce the outside dimension (i.e., the thickness) of the chamber, e.g., to 0.6 cm or less, and to minimize the thickness (width) of the chamber interior (i.e., as measured between the first and second major side walls) to approximately 0.5 cm or less. With a chamber thickness of this scale or even substantially smaller, reduction in the strength of a magnetic field or an electric field passing through the first and second major side walls and through the chamber can be limited.

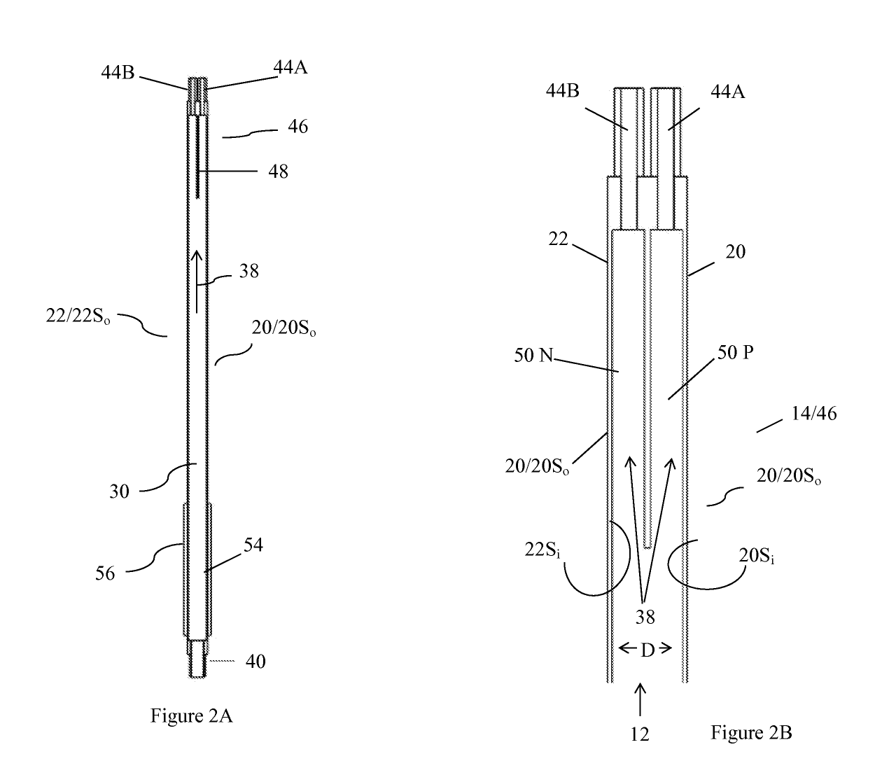

FIGS. 2A and 2B, like FIG. 1B, are sectional views of the chamber apparatus 10 taken along a plane orthogonal to the major side walls 20 and 22. The sectional view of FIG. 2A further illustrates the upper portion 46 of the chamber apparatus 10 shown in FIGS. 1B and 2A. FIG. 2B provides a partial view of the chamber apparatus 10 taken along the minor side wall 30. FIGS. 1A and 2A illustrate a pair of electrode plates 54, 56. Each plate 54, 56 is mounted along a different one of the first and second major sidewalls 20, 22, outside of the chamber interior, and extends from near the lower end wall of the chamber approximately eight to twelve cm toward the upper chamber end to create two parallel electrode plates of approximately equal size. The plate 54, positioned on the major sidewall surface 20Sₒ, is connected to receive a negative or ground potential while the plate 56, positioned on the major sidewall surface 22Sₒ is connected to receive a positive potential. Although not shown, outer surfaces 54ₒ and 56ₒ of the plates 54, 56, which face away from the chamber 14, and other exposed regions of the plates are coated or otherwise covered with electrically insulating material, e.g., for safety. For example, exposed surfaces of the plates may be covered with thin sheets of acrylic.

The parallel plates 54, 56 are formed of a non-magnetic conductive material (e.g., copper or aluminum) which may be in the form of a flexible foil or may be of a more substantial thickness depending on the amount of charge to be accumulated on the plates when generating an electric field. The thickness, length and width of each of the plates 54, 56 is not shown to scale in the figures. The plates are electrically isolated from the chamber interior and fluid which flows along the path 34. Each electrode plate 54, 56 includes a connection (not shown) to provide a voltage between the plates and thereby generate a strong electric field which may extend through the chamber interior as the fluid flows along the chamber path. The electrode plate 54 mounted on the first major surface 20Sₒ is connected to receive a negative or ground voltage potential from a DC power supply while the electrode plate mounted on the second major surface is connected to receive a positive voltage from a DC power supply. During processing of the fluid in the chamber apparatus 10, a high voltage potential (e.g., 1 KV to 100 KV) is placed across the electrode plates 54, 56 with a current limited power supply (e.g., with the current limited to the milliamp range).

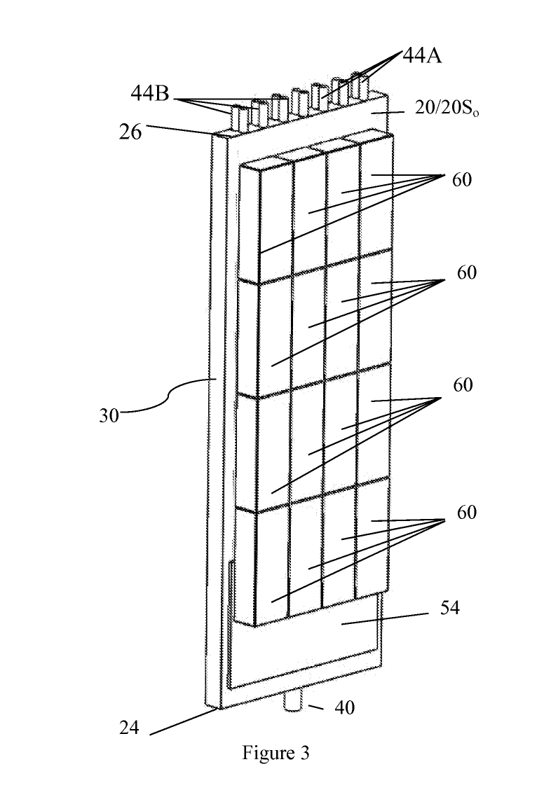

One or more magnets are positioned along substantially the entire first major surface 20Sₒ to provide a magnetic field gradient in the chamber 14. A suitable field could be created with permanent magnets, a normal conducting electromagnet or a superconducting magnet. As shown in FIG. 3, a series of permanent magnets 60 is positioned along substantially the entire first major surface, i.e., the same surface along which the electrode plate 54 is positioned to provide a negative or ground voltage potential. The magnets 60 may be commercially available units approximately 9 cm long and each unit may contain multiple magnets.

The magnet units may be of the high field strength Neodymium type such as used for fluid treatment or anti-corrosion applications based on magneto hydro dynamics, e.g., in large industrial pipes. Individual magnets in a unit may have fields ranging between 0.15 and 0.5 Tesla. The units may be of higher field strength such as made available in the form of Neodymium Magnet Blocks which are manufactured in a variety of sizes such as 15 cm×15 cm×2.5 cm. Such products are made available by Applied Magnets of Plano Texas. Numerous other designs of

[symbol]

With the electrode plate 54 positioned against the outer surface 20Sₒ of the major wall 20, the magnets 60 may be vertically stacked against the outer electrode plate surface 54ₒ and along or against the outer surface 20Sₒ of the major wall 20 to extend upward, with respect to the ground plane, from the lower chamber end wall 24 to near the upper chamber end wall 26 (e.g., past the point along the flow path at which the divider plate 48 creates the two channels).

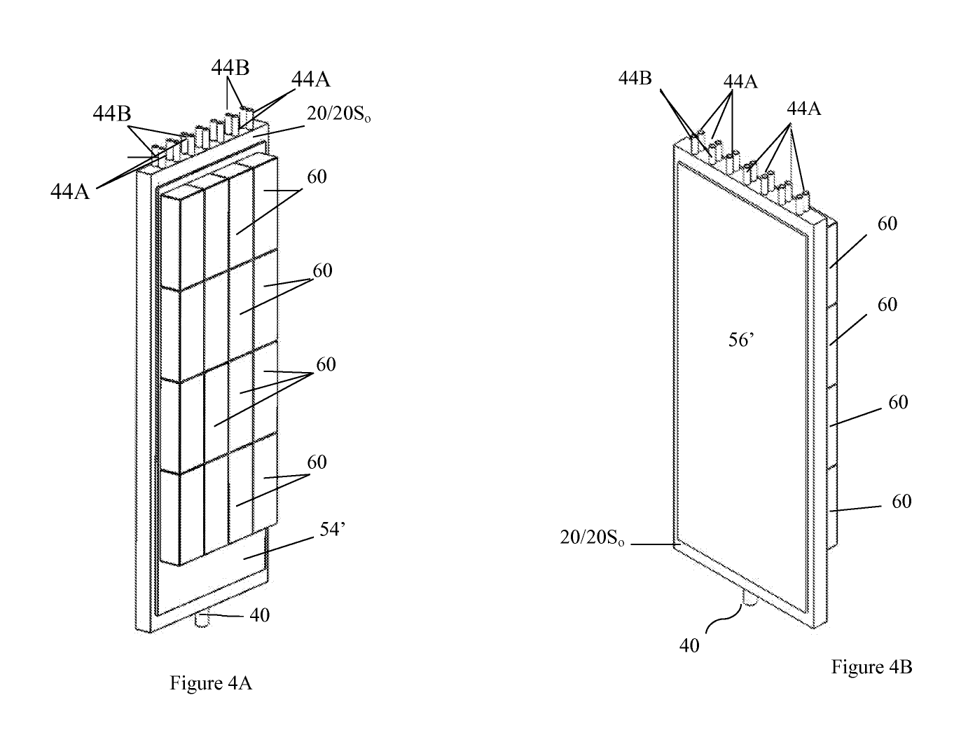

In an alternate configuration of the chamber apparatus 10, the electrode plates 54, 56 are modified as indicated in FIGS. 4 by reference numerals 54′, 56′, where each plate is mounted along a different one of the first and second major sidewalls 20, 22, outside of the chamber interior, but each of the parallel electrode plates 54′, 56′ extends from near the lower end wall 24 of the chamber 14 toward or to the upper end wall 26 of the chamber to create two parallel electrode plates of approximately equal size. The electrode plates 54′, 56′ may extend from the lower end wall 24 to the divider plate 48 or beyond divider plate 48.

The net field (not shown) from the magnet units 60 extends through the field plate 54 or 54′ and through the first major sidewall 20 (e.g., along more than 90 percent of the sidewall surfaces 20Sᵢ, 20Sₒ) so that at least the portions of the chamber near the lower end wall 24 experience a combination of both an electric field and a magnetic field and other portions of the chamber extending above the plates experience at least a magnetic field.

With a system comprising the afore-described flow chamber assembly 10, and a voltage applied across the electrode plates in the presence of field gradient from the magnets 60, movement of cations and anions (e.g., in an aqueous solution of sodium and chlorine ions) can occur in opposite directions. By way of example, again noting that operation of the invention is not limited based on understanding or proof of a particular theory, for a saline solution flowing past the electrode plates 54, 56 or 54′, 56′ positively charged ions are attracted to and migrate toward the surface 20Sᵢ of the first major sidewall 20 under attractive influences of both the magnetic field and the negatively charged electrode plate 54 or 54′ while negatively charged ions migrate toward the surface 22Sᵢ of the second major sidewall 22 under a repulsive influence of the magnetic field and an attractive influence of the positively charged electrode plate 56 or 56′. Forces of sufficient magnitudes can cause a spatial differential, e.g., a gradient, in both cation and anion concentrations between the surfaces 20Sᵢ and 22Sᵢ.

That is, a relatively large concentration of Na⁺ ions may accumulate close to the surface 20Sᵢ of the first major wall 20 and, perhaps, a relatively low concentration of Na⁺ ions may be present close to the surface 22Sᵢ of the second major wall 22. Similarly, a relatively large concentration of Cl⁻ ions may accumulate close to the surface 22Sᵢ of the second major wall 22, with, a relatively low concentration of Cl⁻ ions present close to the surface 20Sᵢ of the first major wall 20. With such a spatial differential in ion concentrations, as flow of the fluid through the flow path 34 continues: (1) positively charged ions attracted toward the first major wall 20, and which have migrated toward the first major surface, may pass into the channel 50P formed between the divider plate and the wall surface 20Sᵢ; and (2) negatively charged ions possibly repelled by the magnetic field and attracted toward the second major wall 22, and which have migrated toward the surface 22Sᵢ, may pass into the channel 50N formed between the divider plate and the wall surface 22Sᵢ.

Electrical measurements indicate that resistivity of a saline solution increases with processing through the chamber apparatus 10, consistent with migration of a measurable portion of the Na⁺ and Cl⁻ ions that become segregated into different channels (i.e., the cation channel 50P and the anion channel 50N), this resulting in a net differential ion concentration between the channels. Processing of the saline solution provides a significant increase in the electrical resistance of the saline solution received into each of the channels 50P and 50N relative to the electrical resistance of the saline solution prior to entering the chamber 14 through the inlet 40. For example, using a design in accord with the chamber apparatus 10, and injecting into the flow path 34 a saline solution prepared from distilled water, having a salt concentration of approximately 200 ppm: under the influence of magnetic and electric forces, a sufficient net differential ion concentration can occur that processed saline solution received from each of the outlets 44A, 44B exhibits approximately a twenty percent increase in resistance relative to characterization measurements for unprocessed solution received into the chamber 14 at the inlet 40.

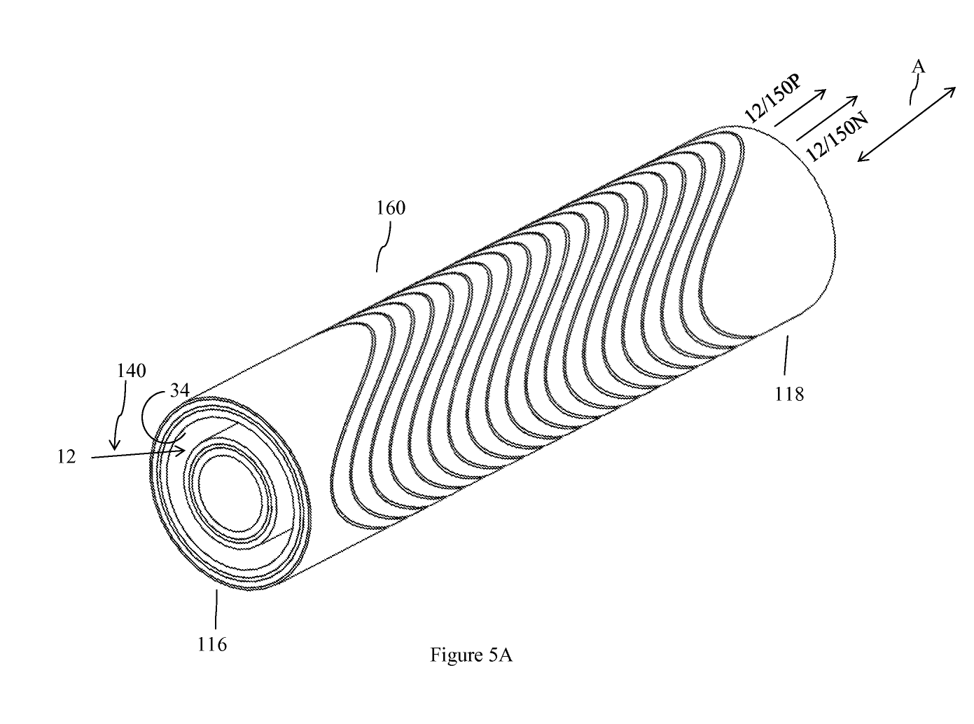

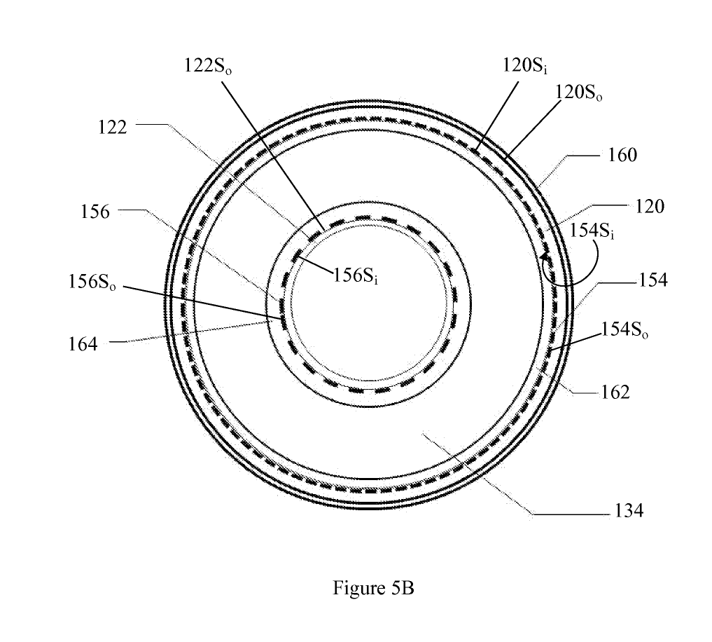

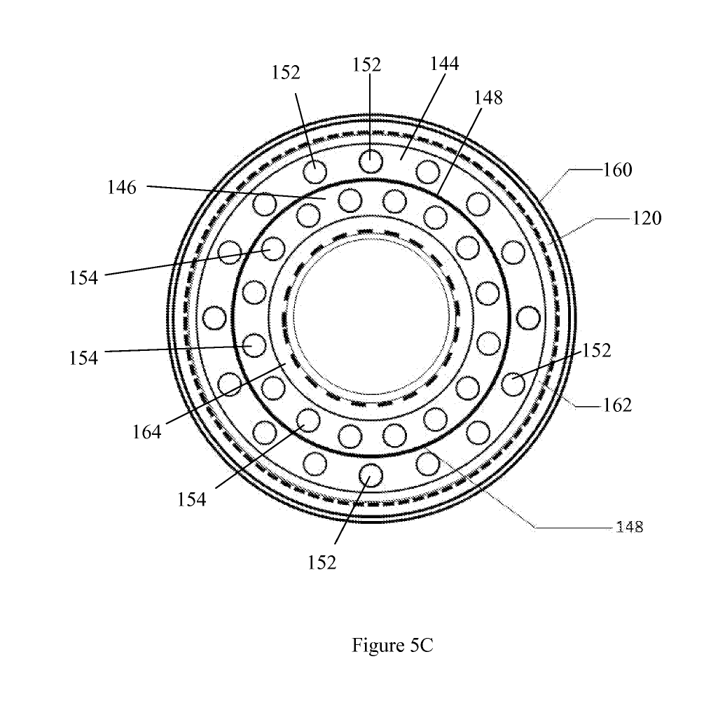

With reference to FIGS. 5A through 5C, several views of a chamber apparatus 100 are shown according to another embodiment of the invention. Like the apparatus 10, the apparatus 100 provides a flow path that facilitates ion separation in a fluid 38 flowing through a chamber 114. The apparatus 100 is a tubular structure having a chamber 114 extending between first and second ends 116, 118. Fluid 12 flows from an inlet region 140 at the first end 116 along a flow path 138 in the chamber 114 and exits the chamber through outlets 144, 146 at the second end 116. Ion separation is based on application of magnetic or electric fields individually or simultaneously.

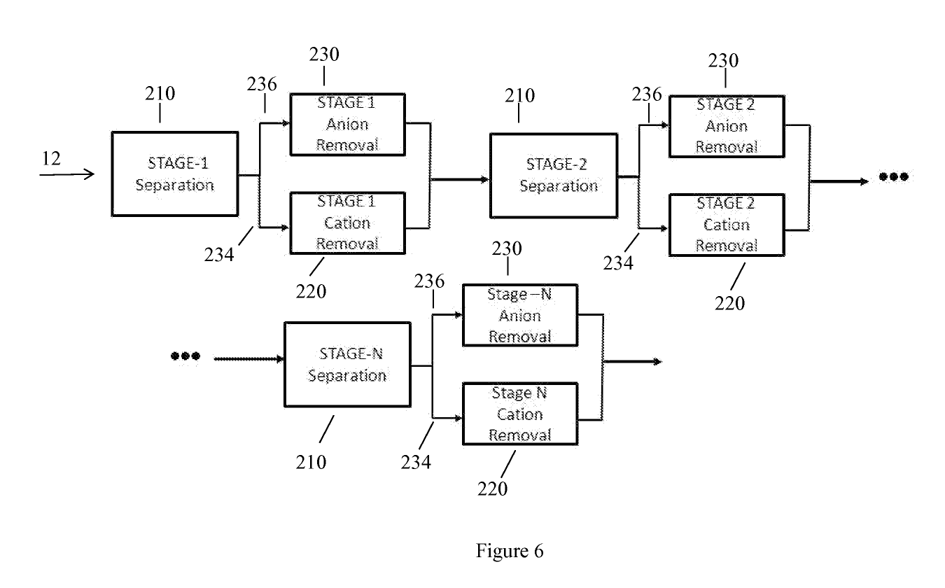

FIG. 5A illustrates the chamber 114 in the form of a cylindrical body of arbitrary dimension formed along a central axis, A, in a horizontal orientation with respect to a horizontal ground plane. Like the chamber assembly 10, the assembly 100 can be oriented in a variety of directions, including a vertical direction with respect to the ground plane. Variable orientation may facilitate assembly of a relatively compact modular system for separation and removal of ions from processed fluids, the system comprising multiple assemblies 10 or 100 as described herein with reference to FIG. 6.

The chamber assembly 100 comprises a pair of cylindrically shaped, outer and inner spaced apart support walls 120, 122 which enclose a volume defining the chamber 114. The walls may be formed of insulative material such as a resin composite material or an acrylic or other plastic material or may comprise a non-magnetic conductive material. The inner wall 122 can be supported within the assembly by connection to the outer wall 120 in a conventional manner.

A magnet 160 is provided around the outer wall 120 to provide a magnetic field in the chamber 114. In this example, the magnet 160 is an electromagnet which may be normal conducting magnet or, for large scale operation of the system 100, a superconducting magnet operating in a persistent current mode. In other embodiments, the magnet 160 may comprise a series of permanent magnets, such as the units described for the assembly 10. The magnet 160 has a winding configuration which produces a quadrupole or higher field configuration (e.g., a sextupole configuration) to provide a field gradient about the axis A. The field gradient of the magnet 160 has a radial dependence, e.g., increasing from no field strength at the axis to a maximum strength along the outer wall 120. For example, a quadrupole configuration will provide a linear gradient, and higher order configurations (sextupole or octupole configurations) will provide larger field gradients. The magnet 160 shown in FIG. 5A may be a double helix magnet such as described in U.S. Pat. No. 7,915,990 and U.S. Pat. No. 7,990,247, each of which is now incorporated herein by reference. Other magnet designs are suitable, including saddle coil magnet designs.

The outer wall 120 has an outer surface 120Sₒ which faces radially outward from the axis, A, and an inner surface 120Si which faces toward the axis. The inner wall 122 has an outer surface 122Sₒ which faces radially away from the axis, and an inner surface 122Sᵢ which faces the axis. An outer electrode plate 154, e.g, a deposited metallic layer, is positioned against the inner surface 120Sᵢ of the outer wall 120, and an inner electrode plate 156, e.g., also a deposited metallic layer, is positioned against the outer surface 122So of the inner wall 122. Generally, the electrode plates 154, 156 are in a cylindrical shape. For the described configuration, the field of the magnet 160 passes through the electrode plates 154, 156, which are formed of non-magnetic conductive material (e.g., copper, aluminum or a semiconductor). The electrode plates may each be in the form of a deposited layer or a foil, or may be of a more substantial thickness (e.g., a pre-formed plate) depending on the amount of charge to be accumulated on the plates when generating an electric field between the plates.

The electrode plates 154, 156 are represented in the figures with dashed lines. The inner surface 154Sᵢ of the outer electrode plate 154 faces the outer surface 156Sₒ of the inner electrode plate 156. The electrode plates are electrically isolated from the chamber 114 and other components of the apparatus 100. Specifically, the inner surface 154Sᵢ of the electrode plate 154 is electrically isolated (e.g., covered with a first insulative layer 162) from the chamber 114, and the outer surface 156Sᵢ of the electrode 156 is also electrically isolated (e.g., covered with a second insulative layer 164) from the chamber 114. The chamber 114 is a cylindrically shaped volume bounded by the insulative layers 162 and 164 to provide a flow path 134 for fluid 12 passing through the assembly 100.

Also for this example embodiment, the interface between the outer surface 154Sₒ of the electrode plate 154 and the inner surface 120Si of the surrounding outer wall 120 is non-conductive. That is, the wall 120 may be formed entirely of insulative material, or an insulative layer (not shown) may be interposed between the inner surface 120Sᵢ and the outer surface 154Sₒ of electrode 154. The interface between the inner surface 156S, of electrode 156 and the outer surface 122Sₒ of the inner wall 122 is also non-conductive. The wall 122 may be formed entirely of insulative material, or an insulative layer (not shown) may be interposed between the outer surface 122Sₒ and the inner surface 156Sᵢ of electrode 156.

The apparatus 100 includes a divider plate 148 which extends from the second end 118 toward the first end 116. The plate 148 is cylindrical in shape and concentrically positioned about the axis A, between the insulative layers 162 and 164 to divide a portion of the chamber 100 adjoining the second end 118 into two separated channels 150P, 150N of approximately equal size. The channel 150P extends between the divider plate 148 and the layer 162 and the channel 150N extends between the divider plate 148 and the layer 164. The divider plate 148 extends a sufficient distance from the second end 118 and toward the first end 116 that (i) the channel 150P serves as a path for flow of cations accumulating near the layer 162 through the channel 150P and the outlet 144 and (ii) the channel 150N serves as a path for flow of anions accumulating near the layer 164 through the channel 150N and the outlet 146. The outlet 144 only receives flow from the channel 150P and the outlet 146 only receives flow from the channel 150N. Consequently, fluid 12 flowing through each distinct channel, 150P or 150N, is only passed through one of the outlets 144 or 146 for further processing, e.g., removal of cations or anions. The outlet 144 is a ring shaped flat plate or a ring shaped portion of a flat plate, having a series of apertures 152 formed therein. The outlet 144 is attached to the channel 150P at the second end 118 of the apparatus 100 to provide controlled exit openings (e.g., the apertures 152) from which fluid 12 may exit the channel 150P and be directed into an anion removal stage in a system for removal of ions from processed fluids. Similarly, the outlet 146 is also a ring shaped flat plate or a ring shaped portion of a flat plate, having a series of apertures 154 formed therein. The outlet 146 is attached to the channel 150N at the second end 118 of the apparatus 100 to provide controlled exit openings (e.g., the apertures 154) from which fluid 12 may exit the channel 150N and be directed into a cation removal stage in a system for removal of ions from processed fluids. The outlets 144 and 146 may be formed in one plate positioned against the divider plate 148 at the second end 118 of the apparatus 100 with the plate extending from the axis A to the outer wall 120.

In the flow chamber assembly 100, with a voltage applied across the electrode plates in the presence of a field gradient from the magnet 160, movement of cations and anions (e.g., in an aqueous solution of sodium and chlorine ions) occurs with the cations and anions moving in opposite directions. Without limiting operation of the invention to any particular theory, with a saline solution flowing past the electrode plates 154 and 156, positively charged ions are attracted to and migrate toward the surface 120Sᵢ of the wall 120, under attractive influences of both the magnetic field and the negatively charged electrode plate 54 or 54′; and negatively charged ions migrate toward the surface 122Sₒ of the wall 122, possibly under a repulsive influence of the magnetic field gradient and an attractive influence of the positively charged electrode plate 156. Forces of sufficient magnitudes can cause a spatial differential, e.g., a gradient, in both cation and anion concentrations between the surfaces 120Sᵢ and 122Sₒ. That is, a relatively large concentration of Na⁺ ions may accumulate close to the surface 120Sᵢ of the wall 120 and, perhaps, a relatively low concentration of Na⁺ ions may be present close to the surface 122Sₒ of the wall 122. Similarly, a relatively large concentration of Cl⁻ ions may accumulate close to the surface 122Sₒ of the wall 122, with a relatively low concentration of C⁻ ions present close to the surface 20Sᵢ of the first major wall 120.

With such spatial differentials in ion concentrations, as movement of the fluid through the flow path 34 continues: (1) positively charged ions attracted toward the first major wall 20, and which have migrated toward the first major surface, may pass into the channel 50P formed between the divider plate and the wall surface 20Sᵢ (referred to as the Na⁺ channel); and (2) negatively charged ions, possibly repelled by the magnetic field and attracted toward the second major wall 22, and which have migrated toward the surface 22Sᵢ, may pass into the channel 50N formed between the divider plate and the second major surface (referred to as the Cl⁻ channel). There results a net differential ion concentration between the channels, and repeated processing of the saline solution provides a significant increase in the direct current electrical resistance of the saline solution received into each of the channels 50P and 50N relative to the electrical resistance of the saline solution prior to entering the chamber 14 through the inlet 40. The net differential cation and anion concentration of fluid passing into the channels 150P and 150N may be influenced by multiple variables, including channel width (i.e., the distance between electrode plates), rate of fluid flow along the flow path, fluid temperature, charge density on the electrode plates, separation distance between electrode plate, and the magnitude of the magnetic field gradient in the chamber.

A modular system 200 for separation and removal of cations and anions from a fluid is illustrated in the block diagram of FIG. 6. The system 200 incorporates multiple stages, N, for repeated processing of a fluid. Each stage comprises a module 210 for separation of cations and anions, a module 220 for cation removal from the fluid, and a module 230 for anion removal from the fluid. The module 210 may comprise the apparatus 10 or the apparatus 100.

The module 210 receives the fluid 12 and develops a net differential ion concentration in the flow for both cations and anions. A portion of the flow having a greater net cation concentration and a lower net anion concentration is output into a first channel 234, e.g., channel 50P. A portion of the flow having a greater net anion concentration and a lower net cation concentration is output into a second channel 238, e.g., channel 50N. Fluid exiting the first channel 234 is received into the module 220 for cation removal from the fluid. Fluid exiting the second channel 238 is received into the module 220 for anion removal from the fluid. Repeated processing of the fluid via the multiple stages of modules 210, 220 and 230 further reduces the net concentration of cations and anions until an acceptable level of ion concentration is reached.

Some or all of the cation removal modules 220 may comprise a cation exchange resin, and some or all of the anion removal modules 230 may comprise an anion exchange resin. In one embodiment the cation exchange resin is in the H⁺ form and the anion exchange resin is in the OH⁻ form. The modules 220 and 230 of later stages may incorporate reverse osmosis alone or in combination with exchange resins.

The system may be used to repeatedly remove sodium and chlorine from water, and with each stage of processing in the system 200 there results a net differential ion concentration between the first and second channels 234, 238. Repeated processing of the saline solution further reduces the sodium and chlorine concentration to an acceptable level. However, discussion of sodium ion and chlorine ion removal is exemplary and it will be appreciated that the system 200 is suitable for removing a variety of cations and anions.

While particular embodiments of the invention have been described for processing a saline solution and for which measured increases in direct current resistance of processed solutions have been observed, the illustrated system is exemplary of principles which provide for ion separation and removal. Based on proposed principles of operation it is apparent that several parameters (e.g., flow rate, fluid temperature, field intensities chamber geometries and chamber dimensions) can be varied to optimize performance of the system 200 in order, for example, to reduce ion concentrations in large volumes of fluid, and, in particular, for industrial removal of NaCl or other materials from water, rendering the processed water more suitable for industrial and agricultural uses or human consumption. Although a rectangular shaped chamber and a tubular shaped chamber have been described for processing a saline solution to remove NaCl, other geometries may be suitable in a large volume production environment. Further, the concepts disclosed may be adapted for implementation in a system which recirculates the fluid to repeatedly reduce an ion concentration level with the same apparatus, e.g., the apparatus 114. As noted, in another series of embodiments, a multi-stage system can be constructed which repeatedly processes a fluid to incrementally suppress ion concentration in stages of fluid flow.

There has been described a system a method which decrease ion concentration by passing the fluid along walls of a chamber while magnetic and electric fields extend through the chamber. Generally, the system operates by applying an electric field and or a magnetic field across the fluid to influence movement or migration of ions.

The claimed invention is:

1. A method for removing ions of a common charge type from a fluid, comprising:
passing the fluid through a flow region;
applying a magnetic field to the region while the fluid is flowing through the region to provide a magnetic field gradient in the flow region; and
applying an electric field across the flow region while the fluid is flowing through the region while applying the magnetic field to the region.

2. The method of claim 1 wherein the ions of the common charge type are cations.

3. The method of claim 1 wherein the ions of the common charge type are anions.

4. The method of claim 1 further including separating a portion of the fluid containing a relatively high concentration of the ions from a portion of the fluid containing a relatively low concentration of the ions.

5. The method of claim 4 wherein the fluid contains cations and anions and the step of separating includes separating a first portion of the fluid containing a relatively high concentration of cations from a portion of the fluid containing a relatively low concentration of cations, and separating a second portion of the fluid containing a relatively high concentration of anions from a portion of the fluid containing a relatively low concentration of anions.

6. The method of claim 1 wherein the magnetic field and the electric field are applied in a manner by which a force due to a magnetic field gradient and a force due to an electrical property both influence a cation to move in a first direction and influence an anion to move in a second direction opposite the first direction.

7. A method for separation and removal of cations and anions from a fluid, comprising:
a segregation step by which a first portion of the fluid contains a relatively high concentration of cations and a second portion of the fluid contains a relatively low concentration of cations;
a separation step by which the first portion of the fluid is passed into a first channel and the second portion of the fluid id passed into the second channel;
a first removal step whereby cations are removed from the first portion of the fluid after the segregation step; and
a second removal step whereby anions are removed from the second portion of the fluid after the segregation step.

8. The method of claim 7 where, by performing the segregation step, the second portion of the fluid contains a relatively high concentration of anions and the first portion of the fluid contains a relatively low concentration of anions.

9. The method of claim 7 wherein the sequence of steps of segregation, separation, first removal and second removal are repeated at least once.

10. The method of claim 7 wherein the sequence of steps of segregation, separation, first removal and second removal are repeated multiple times.

11. The method of claim 7 wherein the segregation step includes:
passing the fluid through a flow region;
applying a magnetic field to the region while the fluid is flowing through the region to provide a magnetic field gradient in the flow region; and
applying an electric field across the flow region while the fluid is flowing through the region while applying the magnetic field to the region.

12. The method of claim 7 wherein the first removal step is performed with a cation exchange resin and the second removal step is performed with an anion exchange resin.

13. A system for removing ions from a fluid, comprising:
a chamber connected to receive a fluid flow and deliver a portion of the flow comprising a relatively high portion of the ions to a first outlet and deliver a portion of the flow comprising a relatively low portion of the ions to a first outlet;
a pair of electrodes positioned to apply an electric field across the chamber; and
a magnet positioned to apply a magnetic field across the chamber.

14. The system of claim 13 wherein the magnet is configured to provide a field gradient across the chamber.
